(19) United States
(12) Patent Application Publication
(10) Pub. No.: US 2011/0209695 A1
(43) Pub. Date: Sep. 1, 2011

(54) HEIGHT ADJUSTING ASSEMBLY FOR A BARBECUE STOVE

(76) Inventor: Jui-Ju YEH, Taipei (TW)

(21) Appl. No.: 12/714,697

(22) Filed: Mar. 1, 2010

(51) Int. Cl. A47J 37/07

(52) U.S. Cl. 126/25 A

(57) ABSTRACT

A height adjusting assembly for a barbecue stove has a grill pan, a mounting bracket securely mounted on the grill pan, a retaining panel transversely mounted slidably through the mounting bracket, a guiding ring attached to the retaining panel, a handle rotatably mounted on the mounting bracket and two struts pivotally mounted in the grill pan and connected to the retaining panel. When the handle rotates, the guiding ring and the retaining panel move up and down, and the struts pivot to lower or raise a grate mounted on the struts. Thus, the grate departs from or approaches a grill rack. A distance between a heat source and foods is adjusted and heat applied to the foods is controlled.

### BACKGROUND OF THE INVENTION

1. Field of the Invention

The present invention relates to a height adjusting assembly for a barbecue stove, especially to a height adjusting assembly that supports a grate and adjusts a distance between the grate and a grill rack.

2. Description of the Prior Art(s)

A barbecue stove has a grill rack for supporting food and a grate for placing a heat source, such as heated stones, lit coals or the like, underneath the grill rack.

However, different foods require different temperatures to cook thoroughly and temperature reduces with distance from the grate. Therefore, at a set distance some food will burn without cooking, some food will not cook and other food will dry out before cooking thoroughly. Further, when using exhausted heat sources, such as charcoal and coal, temperature also varies with time so different food need to be cooked at different times.

Also, oil and juices from meat and marinades drop into the heat source and may be lit by the heat source causing irregular heat patches and ash to be kicked up and cover food. To overcome the shortcomings, the present invention provides a height adjusting assembly for a barbecue stove to mitigate or obviate the aforementioned problems.

### SUMMARY OF THE INVENTION

The main objective of the present invention is to provide a height adjusting assembly for a barbecue stove. The height adjusting assembly has a grill pan, a mounting bracket securely mounted on the grill pan, a retaining panel transversely mounted slidably through the mounting bracket, a guiding ring attached to the retaining panel, a handle rotatably mounted on the mounting bracket and two struts pivotally mounted in the grill pan and connected to the retaining panel.

When the handle is rotated, the guiding ring and the retaining panel move up and down, and the struts pivot to lower or raise a grate mounted on the struts. Thus, the grate departs from or approaches a grill rack. A distance between a heat source and foods is adjusted and heat applied to the foods is controlled.

Other objectives, advantages and novel features of the invention will become more apparent from the following detailed description when taken in conjunction with the accompanying drawings.

### BRIEF DESCRIPTION OF THE DRAWINGS

FIG. 1 is an operational perspective view of a height adjusting assembly for a barbecue stove in accordance with the present invention;

FIG. 2 is a perspective view of the height adjusting assembly in FIG. 1, a grill pan shown in phantom lines;

FIG. 3 is an exploded perspective view of the height adjusting assembly in FIG. 1, the grill pan shown in phantom lines;

FIG. 4 is an enlarged perspective view of the height adjusting assembly in FIG. 1;

FIG. 5 is an operational rear view of the height adjusting assembly in FIG. 1, showing a grate raised;

FIG. 6 is another operational rear view of the height adjusting assembly in FIG. 1, showing the grate lowered; and

FIG. 7 is an enlarged perspective view of another embodiment of a height adjusting assembly for a barbecue stove in accordance with the present invention.

### DETAILED DESCRIPTION OF THE PREFERRED EMBODIMENTS

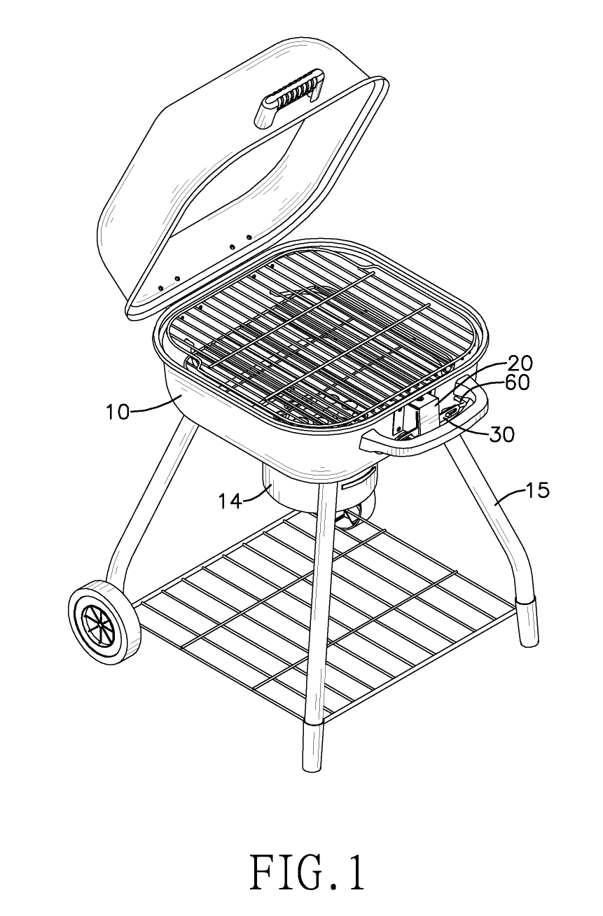

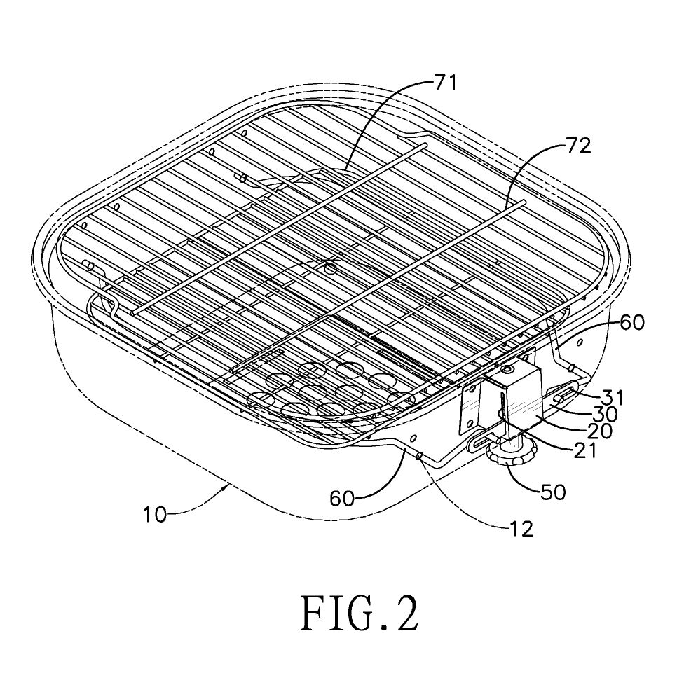

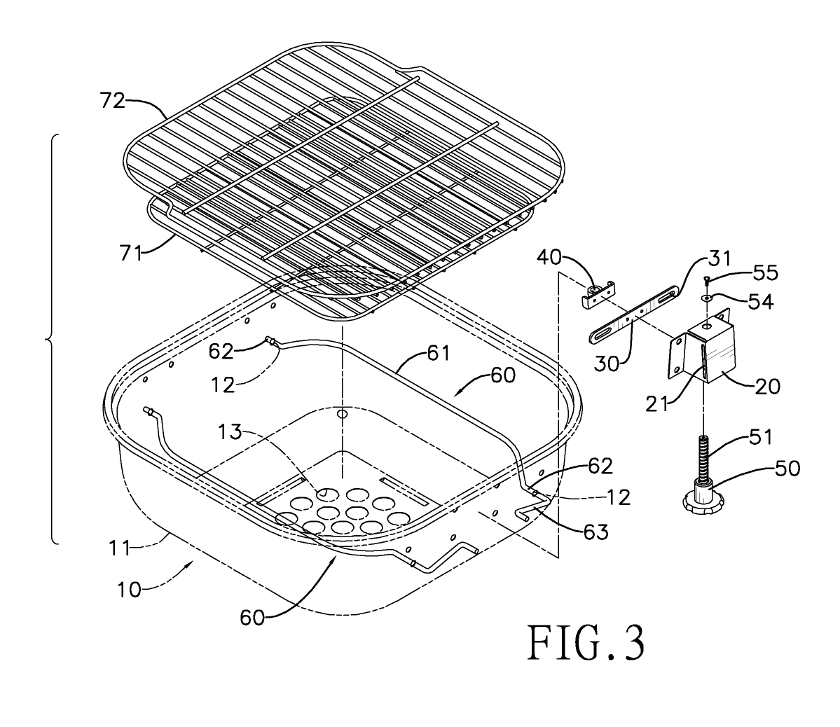

With reference to FIGS. 1 to 3, a height adjusting assembly for a barbecue stove in accordance with the present invention comprises a grill pan (10), a mounting bracket (20), a retaining panel (30), a guiding ring (40), a handle (50) and two struts (60).

The grill pan (10) has a sidewall (11) and two pairs of pivot holes (12) and may have multiple through holes (13), an ash tray (14) and a stand (15). The sidewall (11) is formed around and protrudes up from a bottom of the grill pan (10). The pairs of pivot holes (12) are oppositely formed through the sidewall (11). The through holes (13) are formed through the bottom of the grill pan (10). The ash tray (14) is mounted on the bottom of the grill pan (10) outside the grill pan (10) and corresponds to the through holes (13) for catching ash falling out through the through holes (13) of the grill pan (10). The stand (15) is mounted on the grill pan (10) to support the grill pan (10) up from a plane.

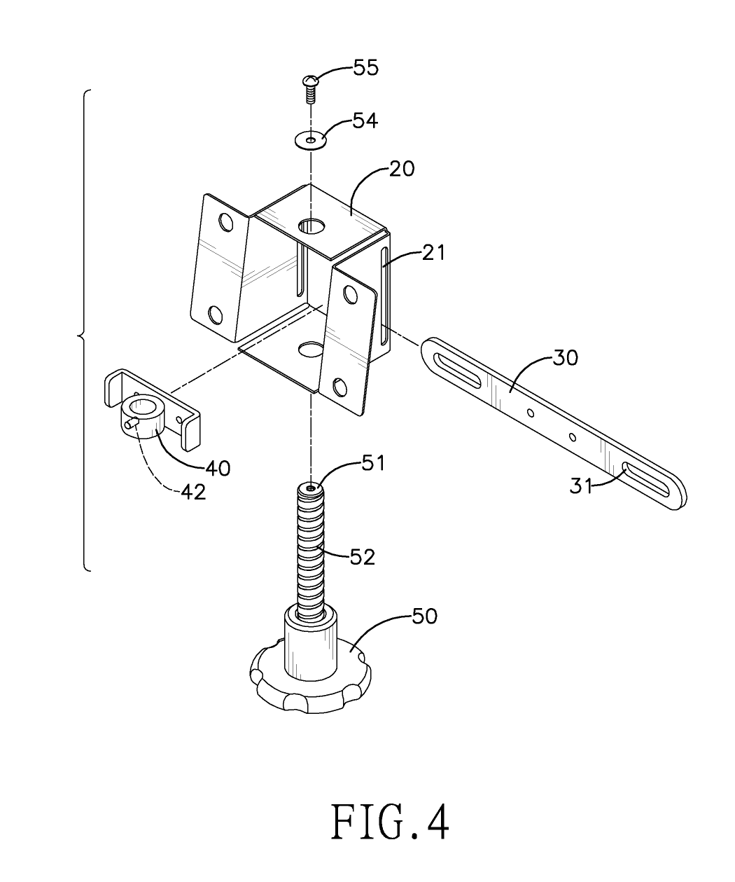

With further reference to FIG. 4, the mounting bracket (20) is securely mounted on an outer surface of the sidewall (11) of the grill pan (10), may be disposed between the pivot holes (12) of a corresponding pair of pivot holes (12) and has two slots (21). The slots (21) are longitudinally formed respectively through two opposite sidewalls of the mounting bracket (20).

The retaining panel (30) is formed elongated, is transversely mounted slidably through the slots (21) of the mounting bracket (20) and has two ends and two sliding holes (31). The ends of the retaining panel (30) protrude out of the mounting bracket (20). The sliding holes (31) are transversely formed through and respectively adjacent to the ends of the retaining panel (30).

The guiding ring (40) is attached to the retaining panel (30), is disposed in the mounting bracket (20) and has a guiding protrusion (42). The guiding protrusion (42) is formed on an inner surface of the guiding ring (40).

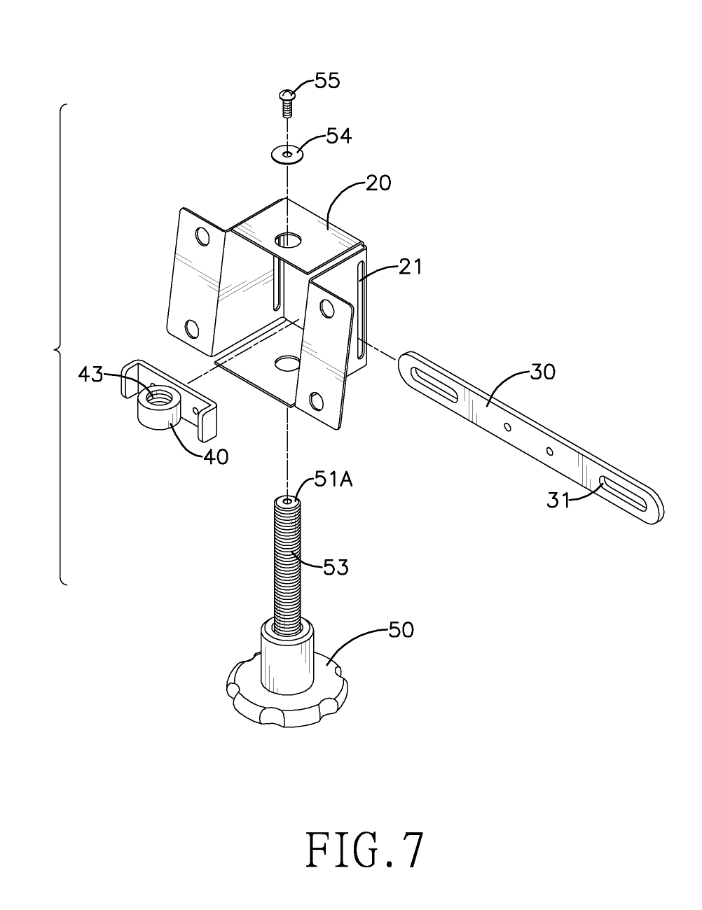

With further reference to FIG. 7, the handle (50) is mounted on the mounting bracket (20) and has a rod (51, 51A) and a spiral groove (52). The rod (51) is mounted through the mounting bracket (20) and the guiding ring (40) and is rotatably attached to the mounting bracket (20). The spiral groove (52) is formed around the rod (51) and engages the guiding protrusion (42) of the guiding ring (40). Thus, when the handle (50) rotates, the guiding protrusion (42) of the guiding ring (40) moves along the spiral groove (52) of the handle (50) and is forced by the handle (50). Consequently, the guiding ring (40) and the retaining panel (30) move up or down along the rod (51) of the handle (50).

In another preferred embodiment, the guiding protrusion (42) may be substituted with an internal thread (43) formed on and around the inner surface of the guiding ring (40). The spiral groove (52) of the handle (50) may be substituted with an external thread (53) formed on and around the rod (51A) of the handle (50) and engages the internal thread (43) of the guiding ring (40). Thus, when the handle (50) rotates, the guiding ring (40) and the retaining panel (30) also move up or down along the rod (51A) of the handle (50).

More specifically, the handle (50) further has a washer (54) and a screw (55). The washer (54) is mounted on an outer surface of the mounting bracket (20). The screw (55) is mounted through the washer (54) and the mounting bracket (20) and is securely attached to an end of the rod (51, 51A). Therefore, the handle (50) only rotates and does not linearly move on the mounting bracket (20).

The struts (60) are pivotally mounted in the grill pan (10). Each strut (60) has an arced support (61), two pivot parts (62) and a lever (63). The arced support (61) has two ends. The pivot parts (62) respectively protrude from the ends of the arced support (61), are bent relative to the arced support (61), are formed parallel to each other and are pivotally mounted through the sidewall (11) of the grill pan (10). Each pivot part (62) is pivotally mounted through one pivot hole (12) of a corresponding pair of pivot holes (12). The lever (63) protrudes from the pivot part (62) that corresponds to the mounting bracket (20), is disposed outside the grill pan (10) and is slidably mounted through a corresponding sliding hole (31) of the retaining panel (30).

When the handle (50) is rotated, the guiding ring (40) and the retaining panel (30) move up and down along the rod (51, 51A) of the handle (50). Thus, the lever (63) of the struts (60) slide in the sliding holes (31) of the retaining panel (30) and pivot at the pivot parts (62) of the struts (60). Moreover, a grate (71) for placing a heat source, such as heated stones, lit coals or the like, is disposed on the arced supports (61) of the struts (60) and a grill rack (72) for placing foods is mounted on the grill pan (10) over the grate (71).

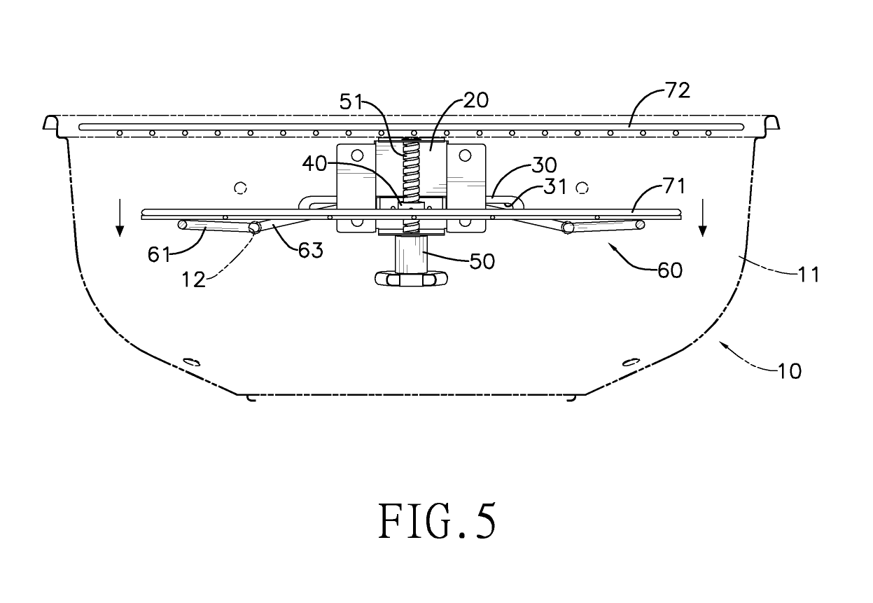

With further reference to FIG. 5, as the handle (30) rotates in a forward direction to pivot the struts (60) upwardly, the grate (71) is raised relative to the grill rack (72).

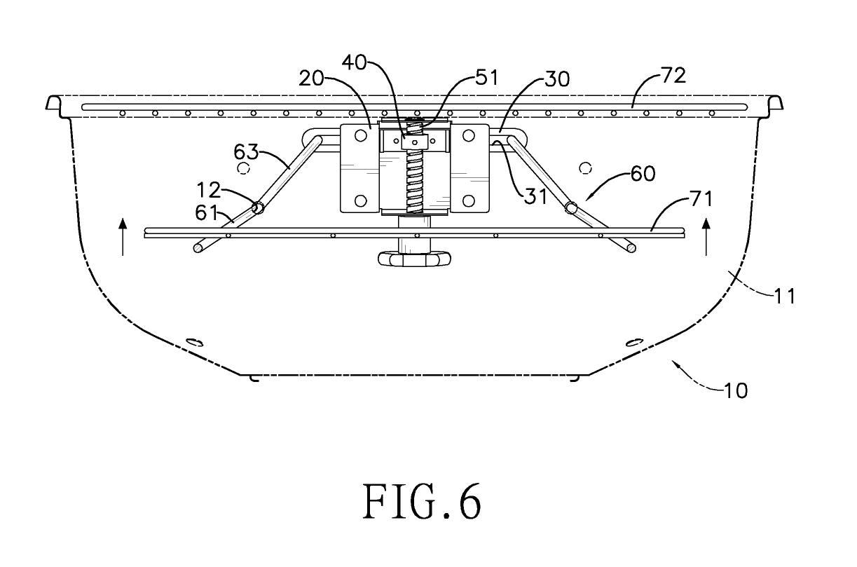

With further reference to FIG. 6, as the handle (30) rotates in a reverse direction to pivot the struts (60) downwardly, the grate (71) is lowered relative to the grill rack (72).

The height adjusting assembly for the barbecue stove as described has the following advantages. The height adjusting assembly supports the grate (71) and holds the struts (60) to stop at specific positions. Therefore, a distance between the heat source and the foods is adjusted according to a temperature of the heat source, kinds of the foods or any other unexpected situations, and heat applying to the foods is controlled.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A height adjusting assembly for a barbecue stove comprising
a grill pan having a sidewall formed around and protruding up from a bottom of the grill pan;
a mounting bracket securely mounted on an outer surface of the sidewall of the grill pan and having two slots longitudinally formed respectively through two opposite sidewalls of the mounting bracket;
a retaining panel formed elongated, transversely mounted slidably through the slots of the mounting bracket and having
two ends protruding out of the mounting bracket; and
two sliding holes transversely formed through and respectively adjacent to the ends of the retaining panel;
a guiding ring attached to the retaining panel, disposed in the mounting bracket and having a guiding protrusion formed on an inner surface of the guiding ring;
a handle mounted on the mounting bracket and having
a rod mounted through the mounting bracket and the guiding ring and rotatably attached to the mounting bracket; and
a spiral groove formed around the rod and engaging the guiding protrusion of the guiding ring; and
two struts pivotally mounted in the grill pan, and each strut having
an arced support having two ends;
two pivot parts respectively protruding from the ends of the arced support, bent relative to the arced support and formed parallel to each other and pivotally mounted through the sidewall of the grill pan; and
a lever protruding from the pivot part that corresponds to the mounting bracket, disposed outside the grill pan and slidably mounted through a corresponding sliding hole of the retaining panel.

2. The height adjusting assembly as claimed in claim 1, wherein
the grill pan further has two pairs of pivot holes oppositely formed through the sidewall;
the mounting bracket is disposed between the pivot holes of a corresponding pair of pivot holes; and
each pivot part of each strut pivotally mounted through one pivot hole of a corresponding pair of pivot holes.

3. A height adjusting assembly for a barbecue stove comprising
a grill pan having a sidewall formed around and protruding up from a bottom of the grill pan;
a mounting bracket securely mounted on an outer surface of the sidewall of the grill pan and having two slots longitudinally formed respectively through two opposite sidewalls of the mounting bracket;
a retaining panel formed elongated, transversely mounted slidably through the slots of the mounting bracket and having
two ends protruding out of the mounting bracket; and
two sliding holes transversely formed through and respectively adjacent to the ends of the retaining panel;
a guiding ring attached to the retaining panel, disposed in the mounting bracket and having an internal thread formed on and around an inner surface of the guiding ring;
a handle mounted on the mounting bracket and having
a rod mounted through the mounting bracket and the guiding ring and rotatably attached to the mounting bracket; and
an external thread formed on and around the rod and engaging the internal thread of the guiding ring; and
two struts pivotally mounted in the grill pan, and each strut having
an arced support having two ends;
two pivot parts respectively protruding from the ends of the arced support, bent relative to the arced support and formed parallel to each other and pivotally mounted through the sidewall of the grill pan; and
a lever protruding from the pivot part that corresponds to the mounting bracket, disposed outside the grill pan and slidably mounted through a corresponding sliding hole of the retaining panel.

4. The height adjusting assembly as claimed in claim 3, wherein
the grill pan further has two pairs of pivot holes oppositely formed through the sidewall;
the mounting bracket is disposed between the pivot holes of a corresponding pair of pivot holes; and
each pivot part of each strut pivotally mounted through one pivot hole of a corresponding pair of pivot holes.
